(19) United States
(12) Patent Application Publication
(10) Pub. No.: US 2013/0185217 A1
(43) Pub. Date: Jul. 18, 2013

(54) FEATURE SPECIFICATION FOR AUTHENTICATION FEATURE

(71) Applicants: Michael Fiedler, Munchen (DE); Oliver Paul, Erding (DE)

(72) Inventors: Michael Fiedler, Munchen (DE); Oliver Paul, Erding (DE)

(21) Appl. No.: 13/823,444

(22) PCT Filed: Oct. 25, 2011
(86) PCT No.: PCT/EP11/05379

§ 371 Date: Mar. 14, 2013

(30) Foreign Application Priority Data
Oct. 27, 2010 (DE) 10 2010 049 830.0

(51) Int. Cl. G06Q 30/00

(52) U.S. Cl. CPC G06Q 30/018
USPC 705/317

(57) ABSTRACT

A method for supplying a feature specification of at least one authentication feature connected with a product, wherein a central device deposits in a database of the central device the feature specification and a reference code linked with the feature specification and uniquely marks the product. Within the framework of a request of a checking device, the central device receives a comparison code of the product from the checking device and ascertains the requested feature specification in the database by identifying the reference code corresponding with the comparison code. The ascertained feature specification is transferred at least partly to the checking device. In a subsequent method for checking the authenticity of the product, the checking device verifies one or several of the authentication features of the product on the basis of the received feature specification.

The present invention relates to a method for supplying a feature specification for authentication features through a central device, and to a corresponding central device. Further, the invention relates to a method for checking authenticity on the basis of authentication features through a checking device, and to a system having central device and checking device.

Nowadays a multiplicity of products, such as e.g. valuable or luxurious objects, value documents and security documents, such as e.g. vehicle documents, identification papers, freight documents or the like, are equipped with authentication features which allow a check of the authenticity of the product by the authentication feature being verified visually or by machine. Such an authenticity check can be carried out by a great variety of bodies and institutions, in particular by government agencies, e.g. customs or enforcement authorities, or private-sector organizations, e.g. banks, merchants or the like.

On account of the great variety of authentication features, their partly covert character, and possible changes of the authentication features used, the problem increasingly arises that, when a product to be checked is present, the existence of an authentication feature, its exact position on the product, and/or the checking methods to be used are not, or not completely, known to the relevant checking body.

In this connection, it is known to perform product identifications and product serializations, for example via bar codes or other unique markings, which, however, normally offer at best low protection from forgery on account of their easy forgeability. Likewise, it is known to record the life cycle of products in centralized fashion, also taking account of authenticity checks on the basis of authentication features. However, the actual verification of the authentication features is not affected by such solutions.

Therefore, the object of the present invention is to make possible an efficient and flexible authenticity check of products that are equipped with at least one authentication feature. This object is achieved by methods and devices having the features of the independent claims. In claims dependent thereon, advantageous embodiments and developments of the invention are stated.

According to the invention, a central device supplies a feature specification which relates to at least one authentication feature connected with a product and can be requested by a checking device in order to check the authenticity of the product through a verification of the authentication feature according to the feature specification.

For this purpose, the feature specification is deposited in a database of the central device so as to be linked with a reference code which uniquely marks the relevant product. Upon reception of a request from a checking device which comprises a comparison code of the product, the central device ascertains the requested feature specification in the database by the latter being identified on the basis of the reference code corresponding with the comparison code. Finally, at least a part of the feature specification is transferred to the checking device.

The feature specification deposited in the database of the central device comprises diverse information items about the relevant, at least one authentication feature of the product to be checked, for example information about the presence of the authentication feature on the product, about the exact position of the authentication feature on the product and/or about the manner in which the authentication feature can be verified. There results a simple and efficient check of the product authenticity through the checking device or through an operator of the checking device on the basis of the feature specification. Because the checking device or its operator in this way always has current information about the existence and verifiability of the authentication feature, a simple and targeted check of product authenticity is guaranteed.

Since a current corresponding feature specification can be utilized simply and quickly when verifying an authentication feature, the forgery-proofness is also increased, because the authentication features used can be regularly replaced or changed.

A feature specification deposited on the central device can comprise readable texts, illustrative images, moving-image sequences, animations, audible instructions, or arbitrary other digital media contents for one or several authentication features which are connected with a certain product. In particular, the feature specification can also comprise control instructions which can be executed by the checking device and cause the latter to automatically verify the relevant authentication feature, or support it in so doing.

In principle, the feature specification can relate to arbitrary authentication or security features employable for product authentication, for example authenticity seals, security labels, optically variable or electronic security elements, security threads, security strips, security foils or also inks and lacquers having certain optical or physical properties, such as for example emission spectra, printed patterns, magnetic fields or the like. In particular, the feature specification relates to so-called covert authentication features, which are not recognizable on the product with the naked eye and are only verifiable by machine using the checking device.

Such covert or hidden authentication features can be applied or provided almost at any place on a product, so that their existence or position on the product already constitutes a security feature. The authentication features specified by the feature specification can also include, besides their security function, further product information, for example the affiliation of a product with a certain product batch or product type, a place of production, a production time, a production method or the like. As such, the authentication features can in particular be configured so as to be individual to a product and thereby have a product-individualizing or batch-individualizing character.

Particularly preferably, a feature specification deposited in the database relates to several authentication features which are all present on a product. Alternatively, however, it is also possible to deposit several feature specifications for a product which respectively relate to only one of the authentication features present on the product. In the case of one feature specification for several authentication features, the central device, or a control device of the central device, can answer a request from a checking device also by there being respectively transferred to the checking device only a part of the requested feature specification, said part relating to only one of several authentication features present on the product.

The central device can control the authenticity check of the product by selecting upon each new request one of several authentication features present and transferring only that part of the feature specification that relates to the selected authentication feature. The checking device can then examine only that one authentication feature whose part of the feature specification it has received from the central device.

Since the central device can in this way individually determine the authentication feature to be verified, there results a further gain in security, because there can then be verified on the part of the checking device e.g. not always only the simplest authentication feature, but rather several authentication features present are drawn on for verification in the course of time in dependence on prescribed criteria. The control device of the central device can select the authentication feature to be verified for example randomly or on the basis of a prescribed distribution or heuristic which takes account of the quality, verifiability or one or several other properties of the authentication features.

Particularly preferably, there is deposited in the database of the central device, preferably together with a feature specification and the appurtenant reference marking, a checking entitlement which allows examination of the entitlement of a checking device, or of an operator operating the checking device, to check the authenticity of the relevant product.

A checking entitlement can relate to a complete feature specification, i.e. to all authentication features of a product, as well as selectively only to individual authentication features of the product, i.e. to the relevant parts of the feature specification. This can be realized on the part of the central device by a tabular structure in which it can be specified in differentiated fashion which checking device and/or operator is entitled to verify which of the, where applicable, several authentication features of a product. The checking entitlements can for example be dependent on a security class of the checking device, of the product or of the relevant authentication feature. For example, it can be provided that only especially trustworthy checking devices, e.g. governmental or official checking devices, may examine especially high-value authentication features, while less trustworthy checking devices, e.g. private checking devices or ones employed in retail trade, may only examine authentication features meeting a lower security standard.

Preferably, these checking entitlements are granted within the framework of a registration process of the checking device vis-à-vis the central device, and assigned to the individual feature specifications or authentication features.

The central device or its control device thus, upon a request, first examines the checking entitlement of the relevant checking device, and transfers the requested feature specification or the requested part of the feature specification only when the checking entitlement is present.

A reference code deposited in the database of the central device can be an arbitrary individualizing or serializing code of the product, for example a bar code individual to the product or to the batch, a batch number or serial number, a digital image of the product or of a certain authentication feature, if the latter is individualized for the product or for the batch, or the like.

The reference codes of the individual products are deposited in the database preferably together with the respectively relevant feature specification. The linkage of a feature specification with the appurtenant reference code can be performed by the control device of the central device or in advance by a producer of the product or of the security feature.

Preferably, the feature specification and the linked reference code are already deposited in the database before delivery of the relevant product to end users or middlemen. The central device receives the feature specification and reference code in advance from a producer device of the product producer or of a producer of the relevant authentication feature, for example within the framework of a product registration process. It is also possible that the central device receives the reference code from a producer device of the product producer, and the feature specification from a producer device of the feature producer, and deposits them in the database so as to be linked with each other on the basis of prescribed criteria.

In a method for checking the authenticity of a product, the checking device is in interaction with the central device such that it directs its request to the central device and receives therefrom the relevant feature specification or the part of the feature specification selected by the central device. Subsequently, the checking device checks the authenticity of the product on the basis of the received feature specification by verifying the relevant authentication feature in accordance with the specification.

A system for supplying a feature specification and subsequently checking the authenticity of the product on the basis of the feature specification comprises a central device, at least one, preferably a multiplicity of, checking devices as well as, where applicable, also producer devices which communicate with each other and exchange data via a supplied data communication network. This data communication network can be an arbitrary suitable communication network, for example the Internet, a mobile radio network, a specialized wide area network (WAN), or the like. The data communication network used can of course also make use of several communication networks.

The various devices interacting via the data communication network are preferably conventional computer devices having a processor, sufficient memory space and suitable interfaces. The checking device can consist of several components which perform the communication and data exchange with the central device, on the one hand, and the concrete checking of the selected authentication feature on the basis of optical or other kinds of physical measuring and verification methods, on the other hand. The central device can in turn comprise a single central server with a suitable control device or also a multiplicity of distributed database servers whose feature specifications, reference codes and checking entitlements are suitably updated or regularly mirrored by the central device.

Further features and advantages of the invention will result from the following description of embodiment examples according to the invention, as well as further alternative embodiments, in connection with the attached drawings which show:

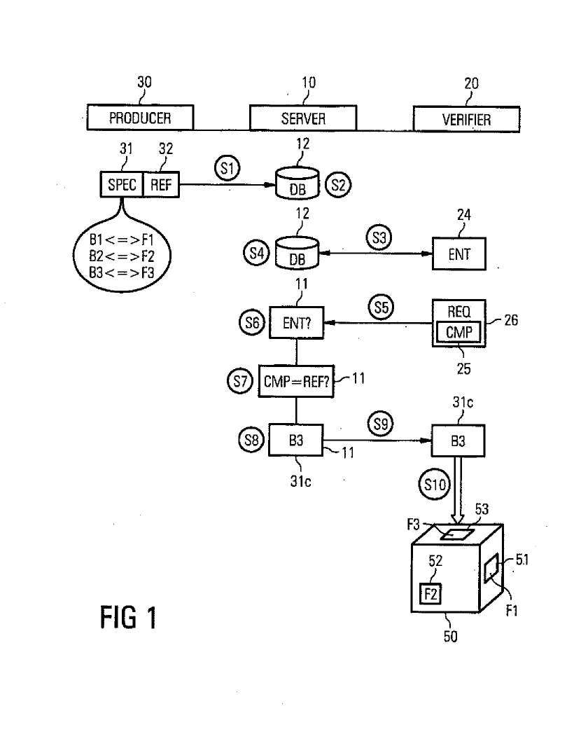

FIG. 1 a flowchart of a method according to the invention for supplying a feature specification and for checking the authenticity of a product on the basis of the feature specification; and

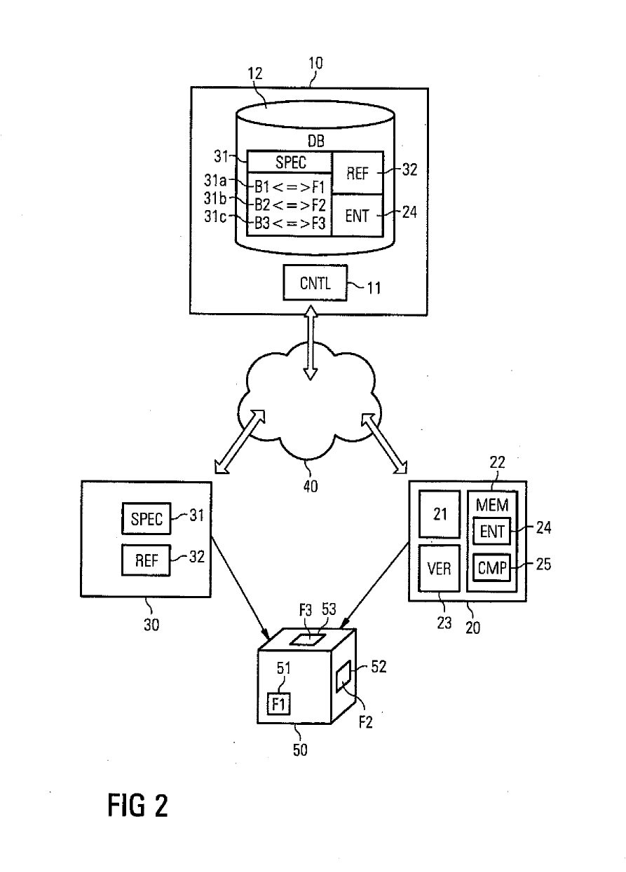

FIG. 2 a supplying and checking system for implementing the method according to FIG. 1.

Hereinafter, some embodiment examples of the present invention will be described on the basis of the method according to FIG. 1 and the system according to FIG. 2.

Participating in the method sketched in FIG. 1 are a producer terminal 30 of a product producer (PRODUCER), a central server 10 (SERVER) as well as a checking unit or verifier 20 (VERIFIER) which respectively represent communication and computing devices equipped with computer technology, or at least comprise such devices. The devices 10, 20, 30 are in data communication with each other via a suitable data communication network 40. The data communication network 40 can be in principle any suitable communication network, for example the Internet, one or several mobile radio networks, or the like. The product producer is seen here to be that body that transfers the data 31, 32 required according to the method to the server 10.

First, a product 50 is produced and provided with one or several authentication features 51, 52, 53 (F1, F2, F3) for later authenticity checking of the product 50. Such products 50 can relate for example to high-quality and/or high-priced or otherwise valuable objects, such as for example luxury products or papers of value in the form of bank notes, identity documents, bank cards, account cards or cash cards, identity cards, vehicle papers, driving licenses, or the like.

The authentication features 51, 52, 53 are normally connected so firmly with the product upon product production that a separation of the authentication features 51, 52, 53 from the product 50 is not possible, or only possible at the price of damaging the product 50. The authentication features 51, 52, 53 are configured here so as to allow an authenticity check of the product 50 as reliably as possible, because they bring about optical, physical or other kinds of effects that are difficult to forge or copy, for example in the form of suitable security features, security threads, optically variable elements, watermarks, electronically readable or accordingly protected labels, or the like. In particular, the authentication features 51, 52, 53 can be incorporated directly into the relevant product 50 or at least into its outer packaging, for example in the form of pigments, fibers, embossings, punchings, or the like. Such authentication features 51, 52, 53 can have in particular properties that are not readily recognizable visually, but can only be recognized and checked by machine, for example using optical scanning. Such authentication features 51, 52, 53 can for example also have magnetic properties or emit in a prescribed manner in spectral regions invisible to the human eye.

For the authenticity checking of a product 50, which has been delivered and is in circulation, by verification of one or several of the authentication features 51, 52, 53 through a verifier 20, the latter, or an operator of the verifier 20, requires detailed information about whether a certain authentication feature 51, 52, 53 is present on the product 50 at all and, if so, how it is positioned there and by which means and methods it can be verified.

FIG. 2 illustrates the information flow between the devices 10, 20, 30 in the course of the method according to FIG. 1, according to which the required feature specification 31 (SPEC) is supplied by the producer terminal 30 and transferred via the data communication network 40 to the central server 10, from where the feature specification 31 can be called up by the verifier 20 again via the data communication network 40. The feature specification 31 comprises information about all authentication features 51, 52, 53 located on the relevant product 50, i.e. in the present example the partial specifications 31a, 31b, 31c (B1, B2, B3) for each individual one of the appurtenant authentication features 51, 52, 53 (F1, F2, F3).

The feature specification 31 and its partial specifications 31a, 31b, 31c can comprise here in principle arbitrary forms and formats of documentation, for example readable texts, instructive images or image sequences and animations, audible instructions in the form of audio files or further suitable, preferably digital, multimedia contents. In particular, the feature specification 31 can also comprise only references (links) to documenting media contents which are suitably deposited on the central server 10 and can be called up by the verifier 20 via the links. This documentation puts the verifier 20, or its operator, in a position to localize the respective authentication feature 51, 52, 53 to be verified on the product 50 and to suitably check it.

In a step S1 of FIG. 1, the producer terminal 30 transfers the feature specification 31 (SPEC) together with a reference code 32 (REF) to the central server 10, whose control device 11 (CNTL) deposits the feature specification 31, linked with the reference code 32, in a database 12 (DB) (step S2), so that the feature specification 31 can be identified in the database 12 via an identification of the corresponding reference code 32. The reference code 32 here is uniquely linked with the feature specification 31, on the one hand, and with the product 50, on the other hand, so that a unique assignment between the feature specification 31 and the relevant product 50 and its authentication features 51, 52, 53 is given via the data deposited in the database 12.

In this case the feature specification 31 and the appurtenant reference code 32 are already supplied in linked form by the producer terminal 30. Alternatively, it is also possible that this linkage is carried out in step S2 by the central server 10. For example, there can be several producer terminals 30, for example one at a product producer via which the reference code 32 is supplied, and one at a feature producer via which the feature specification 31 is supplied. In this case the control device 11 of the central server 10 would produce the linkage between feature specification 31 and reference code 32 on the basis of prescribed criteria.

For requesting the feature specification 31 or one of the partial specifications 31a, 31b, 31c, the verifier 20 must prove it has a checking entitlement 24 (ENT) which the control device 11 examines before outputting the requested feature specification 31 to the verifier 20.

Such a checking entitlement 24 (ENT) is obtained by the verifier 20 within the framework of a registration process vis-à-vis the central server 10 in step S3, by the verifier 20, its operator or the body operating the verifier 20 proving to the body operating the central server 10 that an entitlement to check the authenticity of certain products 50 and thus to verify certain authentication features 51, 52, 53 is present. This entitlement 24 is then deposited in the database 12 by the control device 11 in step S4 such that the entitlement 24 is assigned to the relevant reference code(s) 32 and the relevant feature specification(s) 31 or partial feature specifications 31a, 31b, 31c, and taken into consideration accordingly upon a request of the verifier 20.

The entitlement 24 of a verifier 20 can relate here to certain product batches or feature classes in which a product 50 or its authentication features 51, 52, 53 are to be classified. Likewise, the entitlement 24 can be differentiated in dependence on a security class of the verifier 20 itself or in dependence on the products 50 or their authentication features 51, 52, 53. For example, it can be provided that government-issued documents, such as for example bank notes, proofs of identity or the like, may be checked only by verifiers 20 belonging to a higher security class and utilized e.g. by a bank or government agency having checking entitlement. Other verifiers 20 which are only employed within the framework of an authenticity check of commercial products, e.g. by merchants or other private enterprises, can be assigned to a lower security class comprising only a verification of conventional authentication features 51, 52, 53 that are utilized purely commercially. Thus, it is possible for example that a bank note 50 comprises authentication features 51, 52, 53, whereby a machine-verifiable authentication feature 51 can be checked by arbitrary verifiers 20, and a high-security feature 52, whose structure and verification are substantially confidential, only by especially trustworthy verifiers in banks or government agencies.

In a step S5, the verifier 20 requests the feature specification 31 from the central server 10 by a request 26 (REQ). The request 26 comprises a comparison code 25 (CMP) of the product 50. In a step S6, the control device 11 then first checks the entitlement 24 of the verifier 20, and ascertains in step S7 the reference code 32 corresponding with the comparison code 25 in the database 12, if the entitlement 24 of the verifier 20 to check the product 50 and the authentication features 51, 52, 53 is present.

The reference code 32, which is normally prescribed by the producer of the product 50—and thus also the matching comparison code 25—preferably relates to a product-unique identification, marking or property of the product 50 itself or a corresponding product-unique identification, code or property of one of the authentication features 51, 52, 53 applied to the product. Such a code can be for example a unique serial number, a bar code or another coding or unique designation, or a digital image of the product 50 which has features adequately individual to the product. Likewise, the reference code 32 can also relate to images or other unique markings of an authentication feature 51, 52, 53. If the reference code 32 is derived from the authentication features 51, 52, 53, it relates to adequately individualized properties of these authentication features 51, 52, 53 which make possible a unique assignment to the product 50 and finally to the feature specification 31. The comparison code 25 presented by the verifier 20 within the framework of the request 26 is accordingly configured and suitable for comparison with the corresponding reference code 32 in step S7.

In step S8, the control device 11 of the central server 10 finally selects the partial feature specification 31c (B3) from the feature specification 30 which relates to the authentication feature 53 (F3) and sends it to the verifier 20 in step S9. Finally, the verifier 20 checks the authenticity of the product 50 in step S10 by verifying the authentication feature 53 according to the instructions of the partial feature specification 31c received from the central server 10.

The selection of the partial feature specification 31c in step S8 can, on the one hand, have to do with the checking entitlement 24 of the verifier 20 comprising only the check of the feature 53 and not of the features 51 and 52. On the other hand, the feature 53 and the appurtenant partial feature specification 31c can also be selected individually by the control device 11 according to certain prescribed criteria, for example through a random selection of an arbitrary partial feature specifications 31a, 31b, 31c present in the feature specification 31. Besides the entitlement 24 of the verifier 20, the selection of step S8 can also involve further criteria, for example a security class of the verifier 20 and/or of the individual authentication features 51, 52, 53. In this way, the control device 11 controls the verification of the authentication features 51, 52, 53 and thus the authenticity check of the product 50 in step S10 via a suitable selection of the authentication feature 51, 52, 53 to be verified.

In an optional further step, the verifier 20 can report the results of the verification of the authentication feature 53 back to the control device 11 of the central server 10, in order for the control device to deposit the information in the database 12, for example again linked with the reference code 32 of the product 50, for statistical evaluation of product and feature forgeries or the quality of the relevant verification methods.

The feature specification 31 or the partial feature specifications 31a, 31b, 31c can also comprise, beyond the above-mentioned information and data, control instructions which can be executed directly by the verifier 20 and which cause an automated or partly automated verification of the selected authentication feature 53b. For this purpose, the verifier 20 is equipped with a control component 21 and a memory 22 (MEM) in which for example the checking entitlement 24 and the currently ascertained comparison code 25 are deposited. A verification component 23 (VER) of the verifier 20, which component is connected with the control component, is constructed suitably in terms of apparatus and algorithm to perform the verification of the selected authentication feature 53. The verification component 23 can thus comprise for example a measurement setup, sensors or an evaluating and comparing device in order to be able to check and evaluate optical or other kinds of physical properties of the relevant authentication feature 53 in step S10.

1.-15. (canceled)

16. A method for supplying a feature specification of at least one authentication feature connected with a product, comprising:
depositing a feature specification and a reference code, which is linked with the feature specification and uniquely marks the product, in a database of a central device;
receiving from a checking device a request comprising a comparison code of the product;
ascertaining the feature specification in the database by identifying the reference code corresponding with the comparison code; and
transferring the at least partial feature specification to the checking device.

17. The method according to claim 16, wherein the central device deposits in the database a feature specification which relates to information about the presence of the at least one authentication feature on the product, about the position of the at least one authentication feature on the product, and/or about a possible verification of the at least one authentication feature, and comprises texts, images, animations, audible instructions and/or control instructions executable by the checking device for the at least one authentication feature.

18. The method according to claim 16, wherein the central device deposits in the database a feature specification which relates to at least one authentication feature which is not verifiable with the naked eye.

19. The method according to claim 16, wherein the central device deposits in the database a feature specification which relates to at least one authentication feature individual to a product or individual to a batch.

20. The method according to claim 16, wherein the central device deposits in the database a checking entitlement which relates to an entitlement of the checking device, and/or of an operator operating the checking device, and/or of a body operating the checking device, to check the authenticity of the product or of a product batch including the product, and/or to verify the at least one authentication feature or a feature class including the authentication feature.

21. The method according to claim 20, wherein the central device receives the checking entitlement from the checking device, and transfers the at least partial feature specification to the checking device only after successful examination of the checking entitlement.

22. The method according to claim 16, wherein the central device deposits in the database a feature specification which relates to several authentication features connected with the product, wherein the central device transfers to the checking device, upon the request of the checking device, a part of the feature specification which relates only to one of the several authentication features.

23. The method according to claim 22, wherein the central device, upon the request of the checking device, individually determines the authentication feature to be verified by the checking device, and transfers to the checking device only that part of the feature specification that relates to the authentication feature.

24. The method according to claim 16, wherein the central device deposits in the database a reference code which relates to a bar code, a batch number or serial number and/or a digital image of the product and/or of the at least one authentication feature.

25. The method according to claim 16, wherein the central device deposits in the database the feature specification and the reference code linked therewith, before delivery of the product to an end user or middleman.

26. The method according to claim 16, wherein the central device receives the feature specification of the at least one authentication feature and/or the reference code from a producer device of a producer of the product and/or of the authentication feature.

27. A method for checking the authenticity of a product through a checking device, wherein the checking device cooperates with the central device according to the method recited in claim 16 and checks the authenticity of the product on the basis of the at least partial feature specification received from the central device, by verifying the at least one authentication feature.

28. A central device for supplying a feature specification of at least one authentication feature connected with a product, comprising a database and a control device, wherein the control device is arranged to
deposit in the database the feature specification and a reference code linked with the feature specification and uniquely marking the product;
receive a comparison code of the product from a checking device;
ascertain the feature specification by identifying the reference code corresponding with the comparison code in the database; and
transfer the ascertained feature specification at least partly to the checking device.

29. The central device recited in claim 28, wherein the central device comprises a server connected with a data communication network and configured to carry out the method recited in claim 16.

30. A system comprising a central device and at least one checking device, wherein the checking device comprises a verifier connected with a data communication network and arranged to cooperate with the central device according to the method recited in claim 16 and to check the authenticity of the product on the basis of the received at least partial feature specification by verifying the at least one authentication feature.
